(19) United States
(12) Patent Application Publication
(10) Pub. No.: US 2014/0208230 A1
(43) Pub. Date: Jul. 24, 2014

(54) Autocorrect Highlight and Re-Work

(71) Applicant: APPLE INC., Cupertino, CA (US)

(72) Inventor: Craig Matthew Stanley, Campbell, CA (US)

(73) Assignee: Apple Inc., Cupertino, CA (US)

(21) Appl. No.: 13/745,629

(22) Filed: Jan. 18, 2013

(51) Int. Cl. G06F 3/01

(52) U.S. Cl. CPC G06F 3/01
USPC 715/753

(57) ABSTRACT

Whenever a computing device such as a smart phone automatically corrects and replaces a word entered by the device's user, the computing device can responsively provide some sensory output to the user to signal to the user that the replacement has occurred. Because the user can sense the output, the user can become alerted to the fact of the automatic replacement prior to transmitting, or otherwise making permanent, the text containing the replaced word. The user can then proofread the text prior to transmission in order to ensure that the replaced word is actually the correct word that the user meant to enter. The sensory output can involve a visual highlighting of the replaced word, an audible speaking of the word that replaced the replaced word, and/or a tactile vibration of the computing device, for example.

### BACKGROUND

Mobile devices such as smart phones are capable of participating in text messaging sessions with each other. These mobile devices often enable the entry of text messages through the use of a small virtual keyboard that is presented on the lower half of the mobile devices' touchscreen display. By pressing the virtual buttons on the touchscreen display, a user can enter text that is to be transmitted to another participant in the text messaging session. However, because of the small size of the virtual keyboard and the resulting closeness of the virtual keys to each other, it is relatively common for a user to press the wrong key accidentally; a user might press a key adjacent to the key that he actually intended to press. Consequently, the text that a user enters using a small virtual keyboard is often susceptible to misspellings.

In order to compensate for these misspellings, a mobile device may be equipped with an automatic spell-checking and auto-correction feature. If, during a text messaging session, the user enters a word that is not in the mobile device's dictionary, then the mobile device may attempt to ascertain, automatically, the word that the user most likely meant to spell instead of the misspelled word. The mobile device may automatically replace the misspelled word with the word that is believed to be the correct word. One reason for this automatic replacement is so that the user can quickly continue to participate in his text messaging session, which is sometimes a fairly fast-paced mode of communication that leaves the user little time to proofread all of his text messages prior to sending them to the other participant.

Unfortunately, the word automatically selected by the mobile device as a replacement to the misspelled word might not be the correct word in spite of the fact that the replacement word is correctly spelled. This can lead to comical or tragic results as the texting user unsuspectingly transmits, to the other participant in the text messaging session, a message that ends up meaning something nonsensical, confusing, or subject to severe misinterpretation.

### BRIEF DESCRIPTION

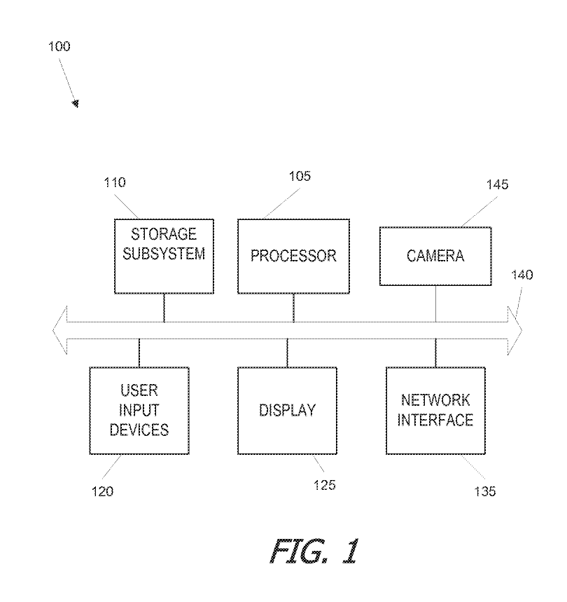

FIG. 1 is a block diagram of a computer system according to an embodiment of the present invention.

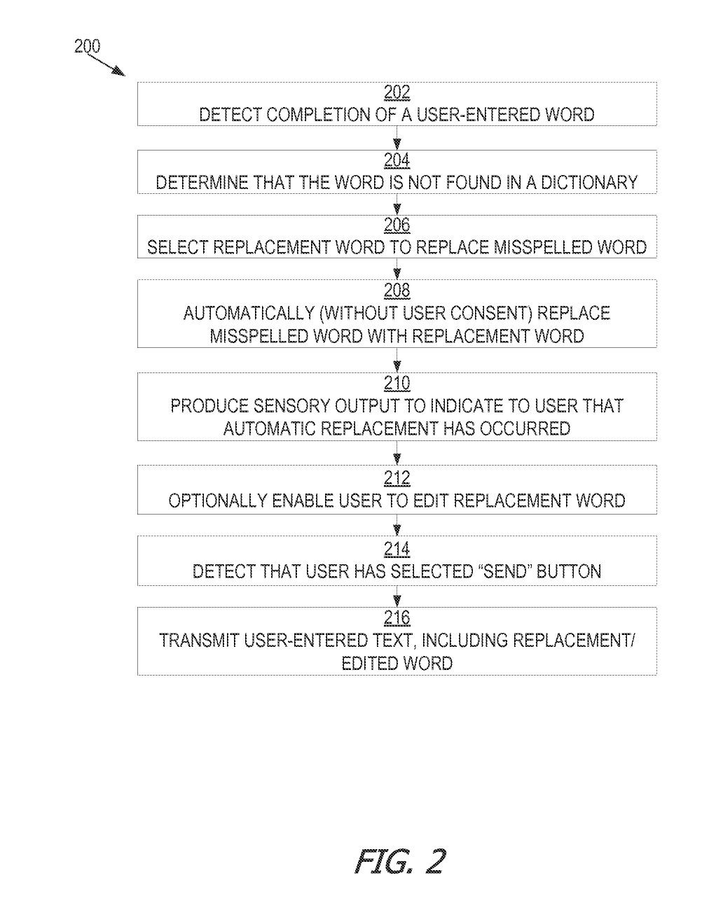

FIG. 2 is a flow diagram that illustrates an example technique for alerting a user that an automatic replacement has occurred relative to text that the user has entered, according to an embodiment of the invention.

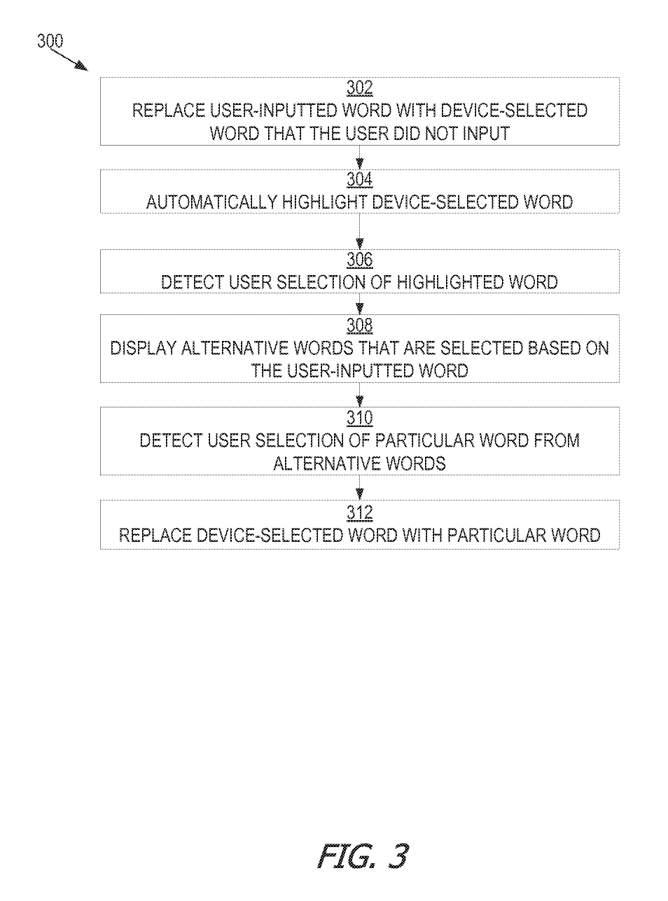

FIG. 3 is a flow diagram that illustrates an example technique for enabling a user to select, from a set of multiple replacement words, an alternative replacement word that better represents the user's intent than does the replacement word that a computing device automatically selected, according to an embodiment of the invention.

### DETAILED DESCRIPTION

Embodiments of the invention relate to the field of automatic spell checking and automatic spell correction by computing devices. According to an embodiment of the invention, whenever a computing device such as a smart phone automatically corrects and replaces a word entered by the device's user, the computing device can responsively provide some sensory output to the user to signal to the user that the replacement has occurred. Because the user can sense the output, the user can become alerted to the fact of the automatic replacement prior to transmitting, or otherwise making permanent, the text containing the replaced word. The user can then proofread the text prior to transmission in order to ensure that the replaced word is actually the correct word that the user meant to enter.

In an embodiment of the invention, the sensory output that the computing device provides in response to automatically replacing a misspelled word can be visual in nature. For example, the computing device can automatically visually distinguish the replaced text from the remaining user-entered text by highlighting, italicizing, underlining, colorizing, or otherwise visually modifying the replaced text. For another example, the computing device can temporarily flash the screen to a brighter or different color in response to and at the time of the replacement of a misspelled word. In an embodiment of the invention, the sensory output that the computing device provides in response to automatically replacing a misspelled word can be audible in nature. For example, the computing device can automatically make a distinct sound at the moment that the computing device replaces a misspelled word with another word within user-entered text. In an embodiment of the invention, the sensory output that computing device provides in response to automatically replacing a misspelled word can be tactile in nature. For example, the computing device can automatically vibrate in a distinct manner at the moment that the computing device replaces a misspelled word with another word within user-entered text. In various embodiments of the invention, the sensory output can be a combination of visual, audible, and/or tactile output.

Rather than merely visually distinguishing a word that is misspelled, so that the misspelled word can be corrected, embodiments of the invention can visually distinguish words that are correctly spelled automatic replacements of previously misspelled user-entered words so that the user is aware of which words in his text are automatic replacement words.

FIG. 1 illustrates a computing system 100 according to an embodiment of the present invention. Computing system 100 can be implemented as any of various computing devices, including, e.g., a desktop or laptop computer, tablet computer, smart phone, personal data assistant (PDA), or any other type of computing device, not limited to any particular form factor. Computing system 100 can include processing unit(s) 105, storage subsystem 110, input devices 120, display 125, network interface 135, and bus 140. Computing system 100 can be an iPhone or an iPad.

Processing unit(s) 105 can include a single processor, which can have one or more cores, or multiple processors. In some embodiments, processing unit(s) 105 can include a general-purpose primary processor as well as one or more special-purpose co-processors such as graphics processors, digital signal processors, or the like. In some embodiments, some or all processing units 105 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 105 can execute instructions stored in storage subsystem 110.

Storage subsystem 110 can include various memory units such as a system memory, a read-only memory (ROM), and a permanent storage device. The ROM can store static data and instructions that are needed by processing unit(s) 105 and other modules of computing system 100. The permanent storage device can be a read-and-write memory device. This permanent storage device can be a non-volatile memory unit that stores instructions and data even when computing system 100 is powered down. Some embodiments of the invention can use a mass-storage device (such as a magnetic or optical disk or flash memory) as a permanent storage device. Other embodiments can use a removable storage device (e.g., a floppy disk, a flash drive) as a permanent storage device. The system memory can be a read-and-write memory device or a volatile read-and-write memory, such as dynamic random access memory. The system memory can store some or all of the instructions and data that the processor needs at runtime.

Storage subsystem 110 can include any combination of computer readable storage media including semiconductor memory chips of various types (DRAM, SRAM, SDRAM, flash memory, programmable read-only memory) and so on. Magnetic and/or optical disks can also be used. In some embodiments, storage subsystem 110 can include removable storage media that can be readable and/or writeable; examples of such media include compact disc (CD), read-only digital versatile disc (e.g., DVD-ROM, dual-layer DVD-ROM), read-only and recordable Blu-Ray® disks, ultra density optical disks, flash memory cards (e.g., SD cards, mini-SD cards, micro-SD cards, etc.), magnetic “floppy” disks, and so on. The computer readable storage media do not include carrier waves and transitory electronic signals passing wirelessly or over wired connections.

In some embodiments, storage subsystem 110 can store one or more software programs to be executed by processing unit(s) 105. “Software” refers generally to sequences of instructions that, when executed by processing unit(s) 105 cause computing system 100 to perform various operations, thus defining one or more specific machine implementations that execute and perform the operations of the software programs. The instructions can be stored as firmware residing in read-only memory and/or applications stored in magnetic storage that can be read into memory for processing by a processor. Software can be implemented as a single program or a collection of separate programs or program modules that interact as desired. Programs and/or data can be stored in non-volatile storage and copied in whole or in part to volatile working memory during program execution. From storage subsystem 110, processing unit(s) 105 can retrieves program instructions to execute and data to process in order to execute various operations described herein.

A user interface can be provided by one or more user input devices 120, display device 125, and/or and one or more other user output devices (not shown). Input devices 120 can include any device via which a user can provide signals to computing system 100; computing system 100 can interpret the signals as indicative of particular user requests or information. In various embodiments, input devices 120 can include any or all of a keyboard, touch pad, touch screen, mouse or other pointing device, scroll wheel, click wheel, dial, button, switch, keypad, microphone, and so on.

Display 125 can display images generated by computing system 100 and can include various image generation technologies, e.g., a cathode ray tube (CRT), liquid crystal display (LCD), light-emitting diode (LED) including organic light-emitting diodes (OLED), projection system, or the like, together with supporting electronics (e.g., digital-to-analog or analog-to-digital converters, signal processors, or the like). Some embodiments can include a device such as a touchscreen that function as both input and output device. In some embodiments, other user output devices can be provided in addition to or instead of display 125. Examples include indicator lights, speakers, tactile “display” devices, printers, and so on.

In some embodiments, the user interface can provide a graphical user interface, in which visible image elements in certain areas of display 125 are defined as active elements or control elements that the user can select using user input devices 120. For example, the user can manipulate a user input device to position an on-screen cursor or pointer over the control element, then click a button to indicate the selection. Alternatively, the user can touch the control element (e.g., with a finger or stylus) on a touchscreen device. In some embodiments, the user can speak one or more words associated with the control element (the word can be, e.g., a label on the element or a function associated with the element). In some embodiments, user gestures on a touch-sensitive device can be recognized and interpreted as input commands; these gestures can be but need not be associated with any particular array in display 125. Other user interfaces can also be implemented.

Network interface 135 can provide voice and/or data communication capability for computing system 100. In some embodiments, network interface 135 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), GPS receiver components, and/or other components. In some embodiments, network interface 135 can provide wired network connectivity (e.g., Ethernet) in addition to or instead of a wireless interface. Network interface 135 can be implemented using a combination of hardware (e.g., antennas, modulators/demodulators, encoders/decoders, and other analog and/or digital signal processing circuits) and software components.

Bus 140 can include various system, peripheral, and chipset buses that communicatively connect the numerous internal devices of computing system 100. For example, bus 140 can communicatively couple processing unit(s) 105 with storage subsystem 110. Bus 140 also connects to input devices 120 and display 125. Bus 140 also couples computing system 100 to a network through network interface 135. In this manner, computing system 100 can be a part of a network of multiple computer systems (e.g., a local area network (LAN), a wide area network (WAN), an Intranet, or a network of networks, such as the Internet. Any or all components of computing system 100 can be used in conjunction with the invention.

A camera 145 also can be coupled to bus 140. Camera 145 can be mounted on a side of computing system 100 that is on the opposite side of the mobile device as display 125. Camera 145 can be mounted on the “back” of such computing system 100. Thus, camera 145 can face in the opposite direction from display 125.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter.

Through suitable programming, processing unit(s) 105 can provide various functionality for computing system 100. For example, processing unit(s) 105 can execute a text messaging application. In some embodiments, the text messaging application is a software-based process that can receive text from a user of computing system 100, automatically replace misspelled words in that text with replacement words, automatically highlight the replacement words, and transmit the text including the replacement words over network interface 135 to a remote computing device.

It will be appreciated that computing system 100 is illustrative and that variations and modifications are possible. Computing system 100 can have other capabilities not specifically described here (e.g., mobile phone, global positioning system (GPS), power management, one or more cameras, various connection ports for connecting external devices or accessories, etc.). Further, while computing system 100 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

FIG. 2 is a flow diagram that illustrates an example technique 200 for alerting a user that an automatic replacement has occurred relative to text that the user has entered, according to an embodiment of the invention. Although technique 200 is shown as involving the performance of particular operations in a particular order, alternative embodiments of the invention can involve more, fewer, and/or different operations than those depicted. Furthermore, in alternative embodiments of the invention, such operations can be performed in an order different from that illustrated.

In block 202, a computing device can detect the completion of a word that a user has entered. For example, the computing device (e.g., a smart phone) can automatically detect the completion of a word due to the user's entry (e.g., via a virtual keyboard presented on the device's touchscreen display) of a special character such as a space character, an enter/line return character, or some form of punctuation. The word can be displayed on the computing device's display, for example; as the user enters each character of the word, that character can be presented on the display. The word can be a part of a text message that the user has typed or spoken (in the case of voice recognition) during a text messaging session. Under such circumstances, the text message can be located within a text entry field that only contains text that has not yet been transmitted to the other participant in the text messaging session. Alternatively, the word can be part of text that the user has inputted into some other application executing on the computing device.

In block 204, in response to detecting the completion of the word, the computing device can determine that the word is not found within the computing device's dictionary. This indicates to the computing device that the word is probably misspelled and ought to be corrected automatically. In an embodiment of the invention, this detection of a misspelled word can take place immediately after the word's completion and prior to the transmission of the text containing the misspelled word.

In block 206, in response to the determination that the word is not found within the dictionary, the computing device can automatically select, from the dictionary, a correctly spelled replacement word to be used to replace the misspelled word automatically. For example, the computing device can select the replacement word based on a quantity of different characters between the misspelled word and the replacement word. For another example, the computing device can select the replacement word based on likely incorrectly pressed keys on the virtual keyboard, determined due to the proximity of those incorrectly pressed keys to keys that the user likely intended to press, whose pressing would have resulted in the typing of the replacement word instead of the misspelled word. For another example, the computing device can select the replacement word based on historical statistical information that indicates, for certain misspelled words, the correctly spelled versions of those words that users (or the device's specific user) have most often intended to type in the past.

In block 208, in response to the selection of the replacement word, the computing device can automatically replace the misspelled word with the replacement word within the user-entered text. The computing device can make this replacement in the text that is visible on the device's display. In an embodiment of the invention, this automatic replacement of a misspelled word can take place immediately after the misspelled word's completion and prior to the transmission of the text containing the misspelled word. Although the misspelled word can be replaced with a single replacement word, in one embodiment of the invention, the misspelled word can be replaced with multiple separate replacement words separated with spaces. This can be the case, for example, when the misspelled word is actually a run-together of multiple words that should have been, but were not, separated by spaces by the user. Under such circumstances, the operations described below with reference to a single replacement word can be applied to the multiple replacement words.

In block 210, in response to the replacement of the misspelled word by the replacement word, the computing device can automatically produce sensory output to indicate, to the device's user, that the replacement has occurred. Such sensory output can be distinct from all other forms of sensory output that the computing device emits in response to other events, so that the device's user can determine from the output that the output specifically signifies the occurrence of an automatic word replacement event rather than some other event. As is discussed above, the sensory output can be visual, audible, and/or tactile. The computing device can vibrate distinctly, emit a distinct sound, and/or highlight or otherwise visually distinguish the replaced word within the displayed user-entered text. In one embodiment of the invention, the computing device can emit, through its speakers, as the distinct sound, a spoken version of the replacement word. By visually distinguishing replaced words from the remainder of the user-entered text, the computing device can not only apprise the user that some word replacement has occurred, but also can make the user aware of exactly which words in the displayed text are replacement words. In an embodiment of the invention, this sensory output can be produced immediately after the word's replacement and prior to the transmission of the text containing the misspelled word, thereby giving the user the opportunity to respond to the replacement (e.g., by proofreading and manually editing the text) prior to the transmission. After the performance of the replacement and the production of the sensory output, the computing device can optionally receive additional text from a user; this additional text can be a part of the same text message that contains the replacement word.

In block 212, the computing device optionally can enable the user to edit the replacement word that has not yet been transmitted or otherwise made permanent. For example, the computing device can detect the user's touch of the replacement word on the touchscreen, and can responsively cause the replacement word to become selected. The computing device can then enable the user to change one or more characters of the selected word using the keys of the virtual keyboard presented on the computing device's display. Potentially, the user can determine that the replaced word actually is the correct word that the used intended to enter, in which case the user might not perform any editing of the replaced word.

In block 214, the computing device can detect that a user has selected a “send” button. For example, the computing device can detect that the user has pressed a virtual “send” button on the user interface that the computing device is presenting on its display.

In block 216, the computing device can transmit the user-entered text, including the replaced and/or edited word, to another computing device. For example, if the text is a text message in a text messaging session, the computing device can wirelessly transmit the text message through one or more computing network to the recipient computing device. The transmitting computing device additionally can move the transmitted text message from the text message entry field of the user interface to the conversation window that contains transmitted text messages that have been made a permanent part of the text messaging session.

The replacement word that the computing device automatically selects to replace the misspelled word can be selected from a set of multiple words that are potential corrected spellings of the misspelled word. Potentially, the computing device can sometimes automatically select a replacement word that was not the word that the user originally intended to enter instead of the misspelled word, but the set of words can still nevertheless contain the word that the user did intend to enter. According to an embodiment of the invention, after a replacement word has been visibly distinguished from other words within a user-inputted text, the computing device can provide a mechanism whereby the device's user can easily change an incorrectly device-selected replacement word to another replacement word from which the device-selected replacement word was automatically selected.

FIG. 3 is a flow diagram that illustrates an example technique 300 for enabling a user to select, from a set of multiple replacement words, an alternative replacement word that better represents the user's intent than does the replacement word that a computing device automatically selected, according to an embodiment of the invention. Although technique 300 is shown as involving the performance of particular operations in a particular order, alternative embodiments of the invention can involve more, fewer, and/or different operations than those depicted. Furthermore, in alternative embodiments of the invention, such operations can be performed in an order different from that illustrated.

In block 302, the computing device can automatically replace a user-inputted word with a device-selected word that the user did not input. For example, the computing device can perform such automatic replacement using technique 200 described above in connection with FIG. 2.

In block 304, the computing device can automatically highlight the device-selected word, thereby distinguishing the device-selected word from other words within text that the user inputted into the computing device. For example, the computing device can perform such automatic highlighting using technique 200 described above in connection with FIG. 2.

In block 306, the computing device can detect a user selection of the device-selected word. For example, the computing device can determine that the user has touched the highlighted word using a touchscreen display on which the highlighted word is presented. For another example, the computing device can determine that the user has mouse-clicked on the highlighted word after maneuvering a graphical pointer over the highlighted word on a display of the computing device. For yet another example, the computing device can determine that the user has audibly spoken the highlighted word into a microphone of the computing device.

In block 308, in response to detecting the user selection of the device-selected word, the computing device can display one or more alternative words that are selected based on the user-inputted word. For example, the computing device might have selected the highlighted replacement word from a set of multiple candidate replacement words that were all potential corrected spellings of the misspelled user-inputted word. However, the word that the user actually meant to input instead of the misspelled user-inputted word might have been another word, other than the highlighted replacement word, from the set of multiple candidate replacement words (the computing device might have automatically chosen incorrectly). Thus, under such circumstances, the computing device can display some or all of the other words from the set of multiple candidate replacement words so that the user can correct the automatic replacement using a technique that is quicker than typing in the correct replacement word that the user actually intended to input in the first place. For example, the computing device can display, in the position of the incorrectly selected highlighted replacement word, a drop-down box control that contains some or all of the other words from the set of multiple candidate replacement words.

In block 310, the computing device can detect a user selection of a particular word from the one or more alternative words. For example, the computing device can detect that the user has touched, via a touchscreen display, a particular replacement word within a drop-down box control that contains some or all of the other words from the set of multiple candidate replacement words.

In block 312, in response to detecting the user selection of the particular word from the one or more alternative words, the computing device can replace the device-selected word with the particular word. For example, in response to detecting that the user has touched a particular replacement word within the drop-down box discussed in the example above, the computing device can replace the device-selected highlighted replacement word with the particular replacement word that the user touched or otherwise selected from the set of candidate replacement words. As a result, the user's intended word replaces the misspelled word in the user-inputted text without requiring the user to type that intended word manually using a keyboard.

Although the other words from the set of multiple candidate replacement words can be shown to the user in a drop-down box, in alternative embodiments of the invention, the other words from the set of multiple candidate replacement words can be shown to the user using other display techniques. For example, in one embodiment of the invention, the other words from the set of multiple candidate replacement words can be organized into separate groups, and each group can be presented to the user on the device's display. One such group can contain words that are spelled similarly to the misspelled word—due to each of those words being no more than a certain quantity of letters different from the misspelled word. Another such group can contain words that contain letters whose keys on the virtual keyboard are adjacent or otherwise proximate to the letters from the misspelled word. In one embodiment of the invention, the phrase (e.g., a specified quantity of words before and after) or sentence containing the misspelled word can be presented somewhere within the user interface shown on the device's display, so that the user can more easily see the context of the word that he is replacing.

As is discussed above, in various embodiments of the invention, the sensory output that the computing device provides to the user in response to the automatic word replacement can take a variety of forms, including visual output, audible output, tactile output, or some combination of these. In an embodiment of the invention, the computing device can provide a settings interface through which the device's user can specify the type of sensory output that the user desires to receive in response to the device performing the automatic word replacement. In an embodiment of the invention, the computing device selects the type of sensory output to produce in response to the automatic word replacement based at least in part on a current physical configuration of switches, buttons, headphone connectors, gyroscopic and/or accelerometer readings, or other physical components of the computing device, which, as discussed above, can be a smart phone. For example, if the smart phone currently has a telephone ringer switch set to “off,” then the smart phone can omit the production of all audible sensory outputs in response to the performance of automatic word replacement, and can instead produce visual and/or tactile sensory outputs (e.g., vibration) in response to the performance of automatic word replacement.

In some embodiments of the invention, user correction of automatically replaced words can be performed prior to the transmission of a text message that contains the automatically replaced word. Such transmission usually occurs in response to the user's selection of a virtual “send” button presented within the user interface of a text messaging session. However, in an alternative embodiment of the invention, in which text messages are sent as iMessages rather than as Short Messaging System (SMS) messages, the computing device can highlight or otherwise visually distinguish automatically replaced words within messages that have already been transmitted and that are already displayed within the text message history window of the user interface. In such an alternative embodiment, the user can touch or otherwise select an automatically replaced word in order to select a corrected word to be substituted for that automatically replaced word, using techniques discussed above. In response to such user correction of an automatically replaced word in a text message that has already been transmitted, the computing device can send a supplementary message to the recipient device, indicating which of the text messages is affected by the correction, and identifying both the corrected word and the word that the user selected as the correct word. In response to receiving such a supplementary message, the recipient device can modify the appearance of the affected text message within its text message history window so that within the affected text message that correct word appears in the place of the corrected word. The recipient device can also provide some indication that the corrected word was edited to become the correct word, so that an accurate record of the text message history can be maintained.

Although certain embodiments of the invention are discussed above in the context of text messages, such as iMessages or SMS messages, in alternative embodiments of the invention, the provision of sensory output in response to the performance of automatic word replacement can be used in contexts other than text messaging. For example, in an alternative embodiment of the invention, the sensory output alerts discussed above can be provided in the context of automatic word replacement that occurs relative to an e-mail message, such as might be transmitted according to the Simple Mail Transfer Protocol (SMTP). In another alternative embodiment of the invention, sensory output alerts can be produces in response to the automatic replacement of misspelled words in a word processing document. Significantly, the visual highlighting that can occur in the word processing document context is a visual highlighting of words that have already automatically replaced other words, rather than a visual highlighting of misspelled words that have not yet been corrected.

Embodiments of the present invention can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above can make reference to specific hardware and software components, those skilled in the art will appreciate that different combinations of hardware and/or software components can also be used and that particular operations described as being implemented in hardware might also be implemented in software or vice versa.

Computer programs incorporating various features of the present invention can be encoded and stored on various computer readable storage media; suitable media include magnetic disk or tape, optical storage media such as compact disk (CD) or DVD (digital versatile disk), flash memory, and other non-transitory media. Computer readable media encoded with the program code can be packaged with a compatible electronic device, or the program code can be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A computer-readable memory storing instructions to cause one or more processors to perform operations, the instructions comprising:
instructions to cause the processors to replace a first word with a second word; and
instructions to cause the processors to produce user-detectable sensory output in response to replacing the first word with the second word.

2. The computer-readable memory of claim 1, wherein the instructions to cause the processors to produce user-detectable sensory output in response to replacing the first word with the second word comprise instructions to cause the processors to visually distinguish the second word from others words in displayed text that includes the second word and the other words.

3. The computer-readable memory of claim 1, wherein the instructions to cause the processors to produce user-detectable sensory output in response to replacing the first word with the second word comprise instructions to cause one or more speakers to emit a sound in response to the replacement.

4. The computer-readable memory of claim 1, wherein the instructions to cause the processors to produce user-detectable sensory output in response to replacing the first word with the second word comprise instructions to cause a computing device to vibrate in response to the replacement.

5. The computer-readable memory of claim 1, wherein the instructions further comprise:
instructions to cause the processors to detect, after production of the user-detectable sensory output, a user's selection of a particular user interface control; and
instructions to cause the processors to transmit, over a wireless network, to a remote computing device, in response to detecting the selection of the particular user interface control, text that includes the second word.

6. A computer-readable memory storing instructions to cause one or more processors to perform operations, the instructions comprising:
instructions to cause the processors to detect, prior to a transmission to a remote device of a text message that a user has entered into a text message entry field of a user interface, a misspelled word within the text message;
instructions to cause the processors to replace, automatically, the misspelled word with one or more corrected words in the text message in the text message entry field in response to detecting the misspelled word; and
instructions to cause the processors to distinguish, visually, from other words in the text message, the one or more corrected words in the text message in the text message entry field in response to replacing the misspelled word.

7. The computer-readable memory of claim 6, wherein the instructions further comprise:
instructions to cause the processors to receive user input that indicates an editing of the one or more characters of the one or more visually distinguished corrected words; and
instructions to cause the processors to change, in the text message entry field, one or more characters of the one or more visually distinguished word with one or more characters indicated in the user input.

8. The computer-readable memory of claim 6, wherein the instructions further comprise:
instructions to cause speakers to emit an audible spoken version of the one or more corrected words in response to the replacement of the misspelled word with the one or more corrected words.

9. The computer-readable memory of claim 6, wherein the instructions further comprise:
instructions to cause the processors to determine whether a ringer switch is currently in an off position; and
instructions to cause the processors to produce sensory output of a type that is based on whether the ringer switch is currently in the off position in response to the replacement of the misspelled word with the one or more corrected words while the ringer switch is currently in the off position;
wherein the type of sensory output is a spoken audible version of the word that automatically replaced the misspelled word while the ringer switch is in an on position; and
wherein the type of sensory output is a vibration while the ringer switch is in an off position.

10. The computer-readable memory of claim 6, wherein the instructions further comprise:
instructions to cause the processors to receive user input that indicates a type of sensory output;
instructions to cause the processors to store the type of sensory output in configuration settings; and
instructions to cause the processors to produce sensory output that matches the type of sensory output stored in the configuration settings in response to the replacement of the misspelled word with the one or more corrected words.

11. The computer-readable memory of claim 6, wherein the instructions further comprise:
instructions to cause the processors to receive user input that indicates a changing of an incorrect word in a transmitted text message to a user-selected correct word; and
instructions to cause the processors to transmit, to a recipient device to which the transmitted text message was transmitted, a supplementary message that identifies the transmitted text message and indicates both the incorrect word and the user-selected correct word.

12. The computer-readable memory of claim 6, wherein the instructions further comprise:
instructions to cause the processors to receive a supplementary message that identifies a particular text message previously received from a transmitting device, that identifies an incorrect word in the particular text message, and that identifies a user-selected correct word;
instructions to cause the processors to replace, in the particular text message, the incorrect word with the user-selected correct word; and
instructions to cause the processors to provide an indication to a user that the user-selected correct word in the particular text message was formerly the incorrect word.

13. A computer-readable memory storing instructions to cause one or more processors to perform operations, the instructions comprising:
instructions to cause the processors to replace, automatically, a user-inputted word with a device-selected word that the user did not input;
instructions to cause the processors to detect a user selection of the device-selected word; and
instructions to cause the processors to display, in response to the detection, one or more alternative words that are selected based on the user-inputted word;
instructions to cause the processors to detect a user selection of a particular word from the one or more alternative words; and
instructions to cause the processors to replace the device-selected word with the particular word in response to detecting the user selection of the particular word from the one or more alternative words.

14. The computer-readable memory of claim 13, wherein the instructions to cause the processors to display the one or more alternative words that are selected based on the user-inputted word comprise instructions to cause the processors to display, in a location of the device-selected word, a drop-down box control that contains the one or more alternative words.

15. The computer-readable memory of claim 13, wherein the instructions to cause the processors to display the one or more alternative words that are selected based on the user-inputted word comprise instructions to cause the processors to display a first group of alternative words that are each no more than a specified quantity of letters different from the user-inputted word; and wherein the instructions to cause the processors to display the one or more alternative words that are selected based on the user-inputted word comprise instructions to cause the processors to display, separate from the first group, a second group of alternative words that each contain one or more letters that are adjacent on a keyboard to letters that the user-inputted word contains.

16. The computer-readable memory of claim 13, wherein the instructions further comprise:
instructions to cause the processors to display, along with the one or more alternative words, a sentence that contains the user-inputted word that one of the one or more alternative words is going to replace.

17. The computer-readable memory of claim 13, wherein the instructions to cause the processors to replace the user-inputted word with the device-selected word that the user did not input comprise instructions to cause the processors to temporarily flash a display on which the replacement is made to a different color.

18. A method comprising:
determining that a first word is not contained in a dictionary of words;
in response to determining that the words is not contained in the dictionary of words, automatically replacing, on a display, the first word with a second word that is contained in the dictionary of words; and
in response to automatically replacing the first word with the second word on the display, audibly emitting a spoken version of the second word at the time of the replacement.

19. The method of claim 18, further comprising:
after audibly emitting the spoken version of the second word, receiving, through a virtual keyboard presented on the display, one or more characters; and
presenting the one or more characters on the display along with the second word.

20. The method of claim 18, wherein the determining that the first word is not contained in the dictionary of words is performed in response to detecting a completion of the entry of the first word in an e-mail message.

21. The method of claim 18, wherein the determining that the first word is not contained in the dictionary of words is performed in response to detecting a completion of the entry of the first word in a word processing document.

22. A mobile device comprising:
a user interface through which a user can enter a plurality of words; and
a memory storing a program that automatically replaces a particular word of the plurality of words in an absence of a user request to perform the replacement, and that causes the mobile device to produce sensory output to the user at a time of the performance of the replacement.

23. The mobile device of claim 22, wherein the memory storing the program stores a program that that causes the mobile device to visually distinguish the particular word from the plurality of words at the time of the performance of the replacement.

24. The mobile device of claim 22, wherein the memory storing the program stores a program that that causes the mobile device to output, through speakers of the mobile device, at the time of the performance of the replacement, sounds that represent a word that replaced the particular word due to the performance of the replacement.

25. The mobile device of claim 22, wherein the memory storing the program stores a program that that causes at least a part of the mobile device to move at the time of the performance of the replacement.
